(19) United States
(12) Patent Application Publication
(10) Pub. No.: US 2013/0175748 A1
(43) Pub. Date: Jul. 11, 2013

(54) COMPLIANCE BUSH AT TRAILING ARM

(71) Applicant: Kazutaka Otsu, Dublin, OH (US)

(72) Inventor: Kazutaka Otsu, Dublin, OH (US)

(73) Assignee: HONDA MOTOR CO., LTD., Tokyo (JP)

(21) Appl. No.: 13/344,767

(22) Filed: Jan. 6, 2012

(51) Int. Cl. B60G 11/22

(52) U.S. Cl. 267/292

(57) ABSTRACT

A compliance bush for a rear suspension of a vehicle includes an outer tube, an inner shaft, a first elastic member, and a second elastic member. The outer tube defines a central axis. A horizontal axis and a vertical axis each intersects the central axis to divide the bush into quadrants. The inner shaft is received in the outer tube and is configured to rotate in a first rotational direction during a braking event. The inner shaft is elongated in a horizontal direction. The first elastic member connects the inner shaft to the outer tube and is substantially disposed within a first lower quadrant. The second elastic member also connects the inner shaft to the outer tube. The second elastic member is disposed on an opposite side of the vertical axis as the first elastic member and is substantially disposed within a second lower quadrant.

### BACKGROUND

The present disclosure relates to a bush that is incorporated into a connecting portion of a vehicle suspension.

A known rear-wheel suspension used for a front-wheel drive vehicle uses a compliance bush attached to a front end portion of each trailing arm to prevent vibration caused by a road surface from being transmitted to the vehicle body.

The compliance bush can also provide an anti-lift function for the vehicle during a braking event. The compliance bush can counteract the front of the vehicle's tendency to “dive” during a braking event. A known compliance bush includes an inner pipe element and rubber elements located outwardly from the inner pipe. The rubber elements span between the inner pipe and an outer pipe element. In a known compliance bush design, the inner pipe is circular in cross-section and the rubber elements are located along a vertical axis, which prevents the inner pipe from translating with respect to the outer pipe during a braking event.

The magnitude of the dive relates to the angle between a line intersecting a pivot axis of the trailing arm and the rotational axis of the rear wheel of the vehicle and a plane horizontal to the road surface. This angle is also limited by the distance between a floor of the vehicle cabin and the road surface. In cases where the floor of the vehicle cabin is relatively low compared to the road surface, the pivot axis of the trailing arm cannot be set high enough to provide a large enough angle to inhibit undesirable diving of the vehicle, especially when known compliance bush designs are used.

### SUMMARY

An example of a compliance bush for a rear suspension of a vehicle that can overcome at least one of the aforementioned shortcomings includes an outer tube, an inner shaft, a first elastic member, and a second elastic member. The outer tube defines a central axis. A horizontal axis intersects the central axis and a vertical axis intersects the horizontal axis and the central axis to divide the bush into two upper quadrants and two lower quadrants. The inner shaft is received in the outer tube and is configured to rotate in a first rotational direction with respect to the outer tube during a braking event. In a cross-section taken normal to the central axis, the inner shaft is elongated in a horizontal direction. The first elastic member connects the inner shaft to the outer tube. The first elastic member is substantially disposed within a first lower quadrant of the two lower quadrants. The first elastic member includes a first end connected with and contacting the inner shaft and a second end connected with and contacting the outer tube. The second elastic member also connects the inner shaft to the outer tube. The second elastic member is disposed on an opposite side of the vertical axis as the first elastic member and is substantially disposed within a second lower quadrant of the two lower quadrants. The second elastic member includes a first end connected with and contacting the inner shaft and a second end connected with and contacting the outer tube. The compliance bush is devoid of at least one elastic member contacting the inner shaft and the outer tube and located entirely within one of the upper quadrants.

Another example of a compliance bush for a rear suspension vehicle includes an outer tube, an inner shaft, a first elastic member, and a second elastic member. The outer tube defines a central axis. The inner shaft is received in the outer tube and is configured to rotate in a first rotational direction with respect to the outer tube during a braking event. The inner shaft defines a center axis parallel or coaxial with the central axis. In a cross-section taken normal to the center axis, the inner shaft is elongated in a horizontal direction. The first elastic member connects the inner shaft to the outer tube. The first elastic member contacts the inner shaft at a first end and contacts the outer tube at a second end. A second elastic member connects the inner shaft to the outer tube. The second elastic member is disposed on an opposite side of the vertical axis as the first elastic member. The second elastic member contacts the inner shaft at a first end and contacts the outer tube at a second end. The outer tube, the inner shaft, the first elastic member and the second elastic member are each configured such that rotation of the inner shaft with respect to the outer tube in the first rotational direction results in lateral movement a distance D of a point on the inner shaft that was intersected by the horizontal axis and the vertical axis prior to rotation of the inner shaft.

Another example of a compliance bush for a rear suspension of a vehicle includes an outer tube, an inner shaft, a first elastic member, and a second elastic member. The outer tube defines a central axis. A horizontal axis intersects the central axis and a vertical axis intersects the horizontal axis and the central axis to divide the bush into two upper quadrants and two lower quadrants. The inner shaft is received in the outer tube. The inner shaft is configured to rotate in a first rotational direction with respect to the outer tube during a braking event. The inner shaft defines a center axis parallel or coaxial with the central axis. In a cross-section taken normal to the center axis, the inner shaft is elongated in a horizontal direction. The first elastic member connects the inner shaft to the outer tube. The first elastic member is substantially disposed within a first lower quadrant of the two lower quadrants. The first elastic member includes a first end connected with and contacting the inner shaft and a second end connected with and contacting the outer tube. The second elastic member connects the inner shaft to the outer tube. The second elastic member is disposed on an opposite side of the vertical axis as the first elastic member and is substantially disposed within a second lower quadrant of the two lower quadrants. The second elastic member includes a first end connected with and contacting the inner shaft and a second end connected with and contacting the outer tube. The bush is devoid of at least one elastic member contacting the inner shaft and the outer tube and located at least substantially within at least one of the upper quadrants of the two upper quadrants and angularly offset from the vertical axis.

### BRIEF DESCRIPTION OF THE DRAWINGS

FIG. 1 is a schematic depiction of a vehicle during a braking event.

FIG. 2 is a perspective view of a rear suspension assembly for the vehicle depicted in FIG. 1.

FIG. 3 schematically depicts a rear passenger of the vehicle shown in FIG. 1 showing a floor of the vehicle and the rear suspension assembly shown in FIG. 1.

FIG. 4 is a schematic depiction of a compliance bush for the rear suspension assembly depicted in FIG. 2 prior to a braking event.

FIG. 5 depicts the compliance bush of FIG. 4 during a braking event.

FIGS. 6-10 depict alternative embodiments of the compliance bush depicted in FIG. 4.

### DETAILED DESCRIPTION

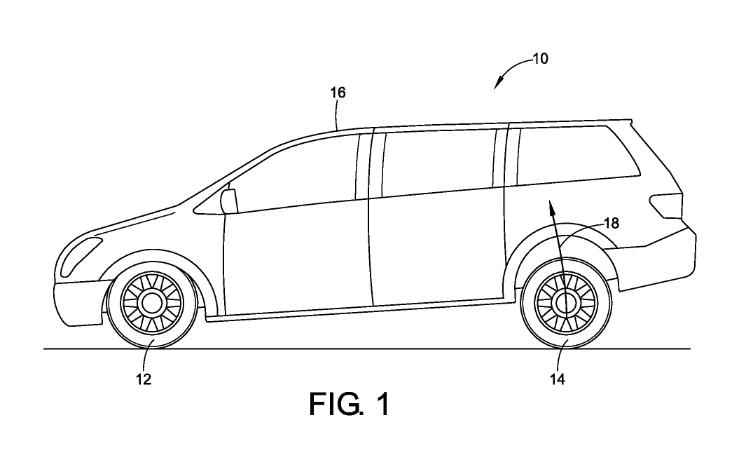

FIG. 1 depicts a vehicle 10 during a braking event. The vehicle 10 includes front wheels 12 and rear wheels 14. The body 16 of the vehicle 10 “dives” forward during the braking event in that a rear section of the body moves upwardly (as depicted by arrow 18) away from the road surface 20 and a forward section of the body moves, or “dives” downwardly. Reducing the magnitude of the dive of the vehicle body 16 is desirable.

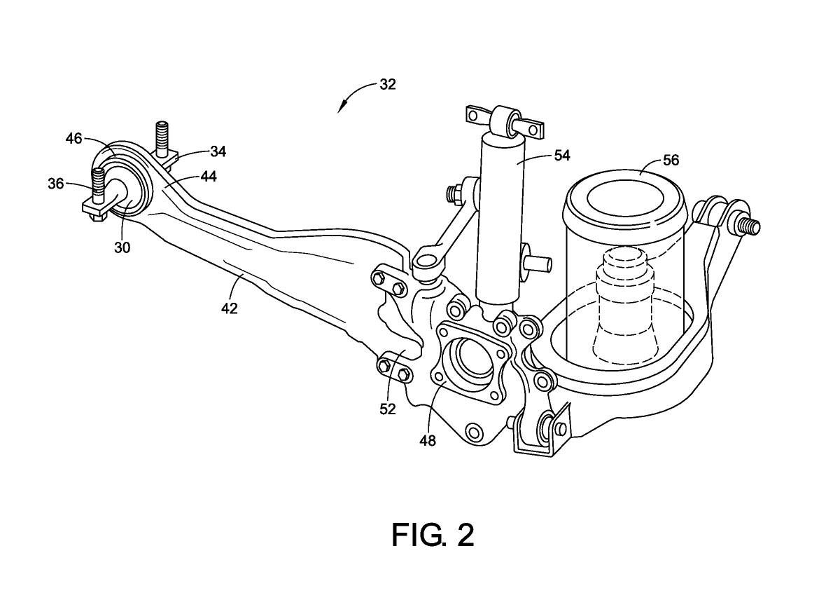

With reference to FIG. 2, a properly designed compliance bush 30, which is a component of a rear suspension assembly 32 of the vehicle 10 (FIG. 1), can reduce the magnitude of the dive during a braking event. The compliance bush 30 receives a shaft 34. The shaft 34 includes bolt holes that receive bolts 36 to connect the bush 30 to a vehicle side bracket (not shown) of a vehicle frame (not shown) of the vehicle 10 (FIG. 1). The design of the compliance bush 30 will be described in more detail below.

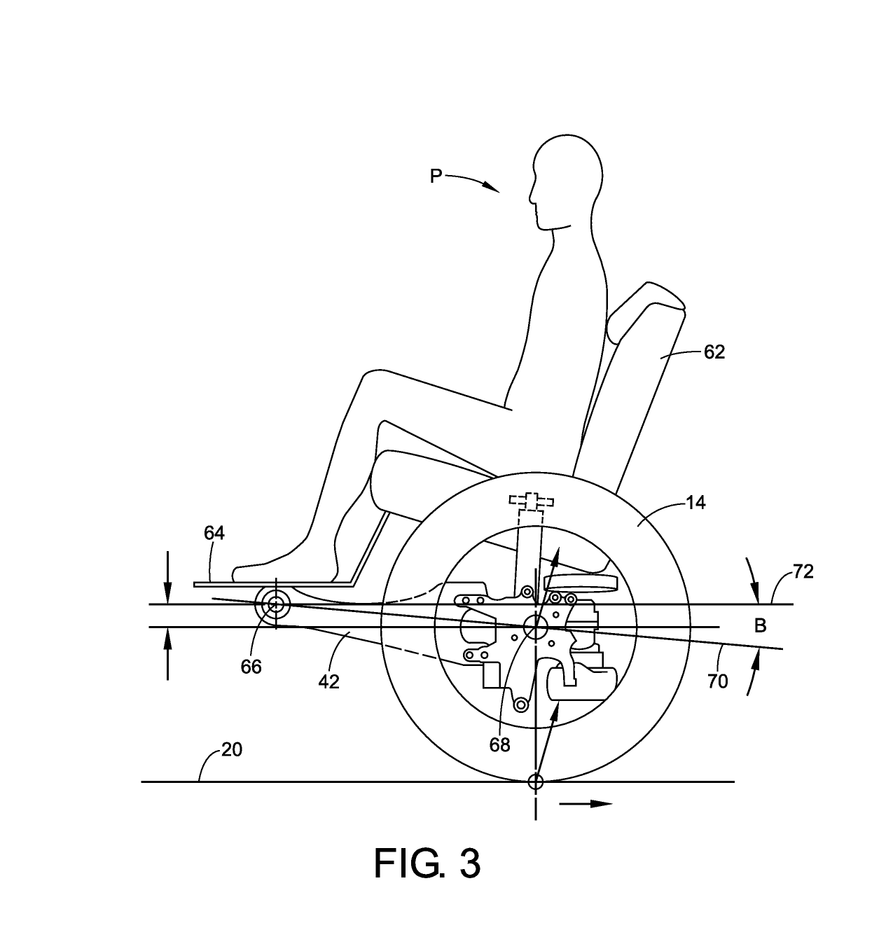

The rear suspension assembly 32 further includes a trailing arm 42. A forward end 44 of the trailing arm 42 includes a transverse bore 46 that receives the compliance bush 30. A wheel mount 48 is found at a rear end 52 of the trailing arm 42. One of the rear wheels 14 (see FIGS. 1 and 3) mounts to the wheel mount 48. The rear suspension assembly further includes a hydraulic damper 54 and a suspension spring (not shown) that is received in a suspension spring shroud 56.

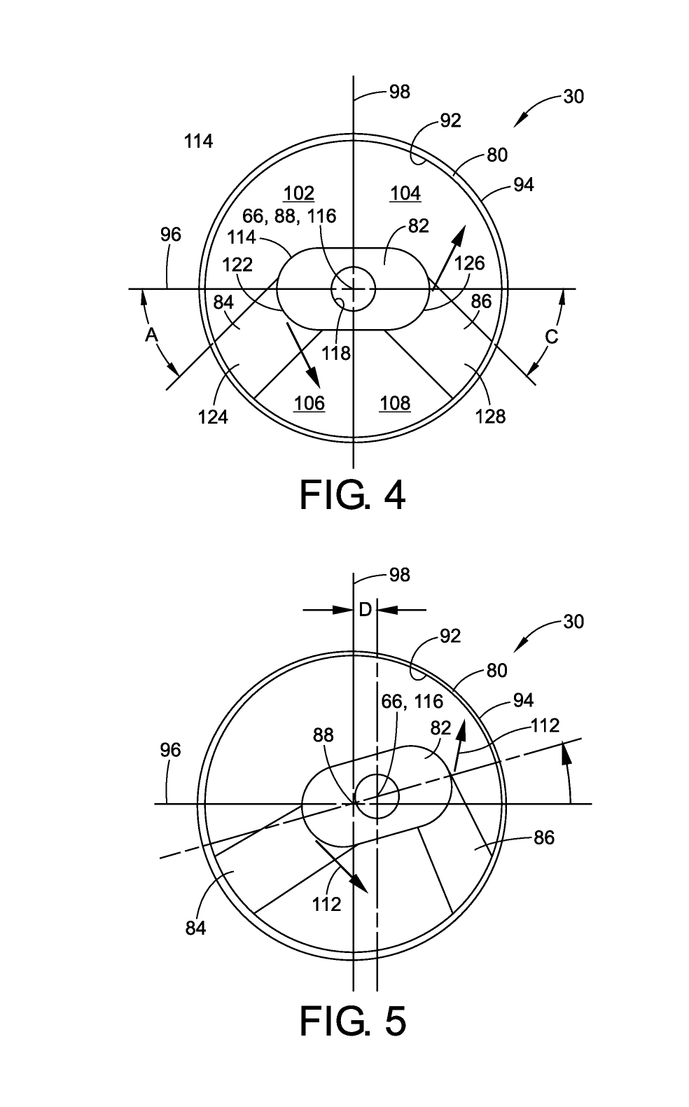

FIG. 3 depicts a rear passenger P seated in a rear seat 62 of the vehicle 10 (FIG. 1). A vehicle floor 64, which can be part of the vehicle body 16 (FIG. 1), is also depicted in FIG. 3. The magnitude of the dive during a braking event, such as that shown in FIG. 1, is in relation to angle B shown in FIG. 3. Axis 66 is a pivot axis about which the trailing arm 42 can pivot with respect to the vehicle frame as the vehicle travels along the road surface 20. Axis 68 is the rotational axis of the rear tire 14. The angle B is the angle in which a line 70 that intersects the axis 66 and the axis 68 is downwardly offset from a plane 72 parallel with the road surface 20. Typically, the greater the angle B, the smaller the magnitude of a dive during a braking event. As can be seen from FIG. 3, however, the location of the axis 66 is limited by the vehicle floor 64. As such, the magnitude of the angle B is also limited. A compliance bush 30 that allows for translation of the axis 66 during a braking event can reduce the magnitude of the dive of the vehicle body where the angle B is the same as compared to a compliance bush that does not allow translation of the axis 66. FIGS. 4-10 schematically depict examples of such compliance bushes.

FIG. 4 schematically depicts the compliance bush 30. The compliance bush 30 includes and outer tube 80, an inner shaft 82, a first elastic member 84, and a second elastic member 86. The outer tube 80 defines a central axis 88, which is coaxial with the pivot axis 66 of the trailing arm 42. (See FIG. 3). FIG. 5 depicts the compliance bush 30 during a braking event, such as that shown in FIG. 1. During the braking event, the pivot axis 66 of the trailing arm 42 (FIG. 3) laterally moves a distance D. Lateral movement of the rotational axis 66 a distance D results in an effective increase of the angle B depicted in FIG. 3, which reduces the magnitude of the dive depicted in FIG. 1.

With reference back to FIG. 4, which shows the compliance bush 30 prior to a braking event, the outer tube 80 is circular in a cross-section taken normal to the central axis 88 such that the outer tube 88 is centered on or circumscribes the central axis 88. The outer tube 80 can be made from a resin-injected molded plastic. The outer tube 80 includes an inner surface 92, which is cylindrical in the embodiment depicted in FIG. 4. The outer tube further includes an outer surface 94, which is also cylindrical in the embodiment depicted in FIG. 4. FIG. 4 further depicts a horizontal axis 96, which intersects the central axis 88 at a right angle. A vertical axis 98 intersects the horizontal axis 96 and the central axis 88 each at a right angle. The horizontal axis 96 and a vertical axis 98 divide the bush 30 into two upper quadrants 102, 104 and two lower quadrants 106, 108.

The inner shaft 82 is received in the outer tube 80. The inner shaft 82 is configured to rotate in a first rotational direction (as depicted by arrows 112) with respect to an outer tube 80 during a braking event. In the embodiment illustrated in FIG. 4, the inner shaft 82 is elliptical in a cross-section taken normal to the central axis 88. As such, in the cross-section taken normal to the central axis 88, the inner shaft 82 is elongated in a horizontal direction. The inner shaft 82 includes an external surface 114, which has the elliptical shape in the cross-section taken normal to the central axis 88. The inner shaft 82 also defines a center axis 116. While the vehicle 10 (FIG. 1) is normally traveling and not during a braking event, the rotational axis 66 of the trailing arm 42, the central axis 88 defined by the outer tube 80, and the center axis 116 defined by the inner shaft 82 are all coaxial. The inner shaft 82 also includes a bore 118, which is coaxial with the center axis 116. The bore 118 receives the shaft 34 (FIG. 1). The inner shaft 82 can be made from steel.

The first elastic member 84 connects the inner shaft 82 to the outer tube 80. As illustrated in FIG. 4, the first elastic member 84 is substantially disposed within a first lower quadrant 106 of the two lower quadrants. The first elastic member 84 includes a first end 122 connected with and contacting the inner shaft 82 and a second end 124 connected with and contacting the outer tube 80.

The second elastic member 86 connects the inner shaft 82 to the outer tube 80. The second elastic member 86 is disposed on an opposite side of the vertical axis 98 as the first elastic member 84. The second elastic member 86 is substantially disposed within a second lower quadrant 108 of the two lower quadrants. The second elastic member 86 includes a first end 126 connected with and contacting the inner shaft 82 and a second end 128 connected and contacting the outer tube 80. Each of the elastic members 84, 86 is interposed and fixed, for example, by means of vulcanizing adhesion, between the inner shaft 82 and the outer tube 30. The elastic members 84 and 86 can be made from a material similar to the outer tube 80. The elastic members 84 limit the rotational and translational movement of the inner shaft 82 with respect to the outer tube 80 during a braking event, such as that shown in FIGS. 1 and 5.

In the embodiment depicted in FIG. 4, while the vehicle 10 (FIG. 1) is traveling normally and not during a braking event, the compliance bush 30 is devoid of at least one additional elastic member contacting the inner shaft 82 and the outer tube 80 and located entirely within one of the upper quadrants 102, 104. With reference back to FIG. 3, in a known compliance bush the pivot axis 66 of the trailing arm 42 is precluded from translation movement during a braking event. One known compliance bush includes elastic members connecting the inner shaft to the outer tube where the elastic members are aligned with the vertical axis 98. In such a known compliance bush, rotational movement of the inner shaft with respect to the outer tube is permitted; however, translational movement of the pivot axis 66 of the trailing arm 42 is inhibited. In other known compliance bushes, elastic members that contact the outer tube 80 in the inner shaft 82 are disposed in the upper quadrants which also limit translational movement of the rotational axis 66 of the trailing arm 42.

As discussed above, the angle B, which is depicted in FIG. 3, is limited when the floor 64 of the vehicle body 16 is low with respect to the road surface 20. Providing a compliance bush 30 that is devoid of at least one elastic member contacting the inner shaft 82 and the outer tube 30 and located entirely within one of the upper quadrants 102 and 104 allows for the desired translational movement depicted a distance D, as shown in FIG. 5. The compliance bush 30 can further be devoid of at least one elastic member contacting the inner shaft 82 in the outer tube 80 and located at least substantially within at least one of the upper quadrants 102, 104 of the two upper quadrants and angularly offset on the vertical axis. Such a compliance bush also allows for the desired translational movement to distance D of the rotational axis 66 of the trailing arm 42 during a braking event. As such, the outer tube 80, the inner shaft 82, the first elastic member 84 and the second elastic member 86 are each configured such that rotation of the inner shaft 82 with respect to the outer tube 80 in the first rotational direction results in lateral movement a distance D of a point, e.g. the pivot axis 66, on the inner shaft 82 that was intersected by the horizontal axis 96 and the vertical axis 98 prior to rotation of the inner shaft 82.

The compliance bush 30 depicted in FIG. 4 is devoid of further elastic members contacting the inner shaft 82 and the outer tube 80 in each of the two upper quadrants 102, 104. In the embodiment depicted in FIG. 4, the second end 124 of the first elastic member 84 is circumferentially spaced along the outer tube 80 from the second end 128 of the second elastic member 86. As is also apparent in FIG. 4, the inner shaft 82 has a periphery, which is defined by the external surface 114, in the cross-section taken normal to the central axis 88 that differs in shape from the configuration of the outer tube in a cross-section taken normal to the central axis. In other words, the inner shaft 82 is elliptical in a cross-section taken normal to the central axis 88 while the outer shaft 80 is circular in a cross-section taken normal to the central axis. In the embodiment depicted in FIG. 4, the first elastic member 84 is disposed downwardly at an angle A from the horizontal axis 96 toward the vertical axis 98. The second elastic member 86 is disposed downwardly at an angle C from the horizontal axis 96 toward the vertical axis 98. In the embodiment depicted in FIG. 4, angle A is substantially equal to angle C.

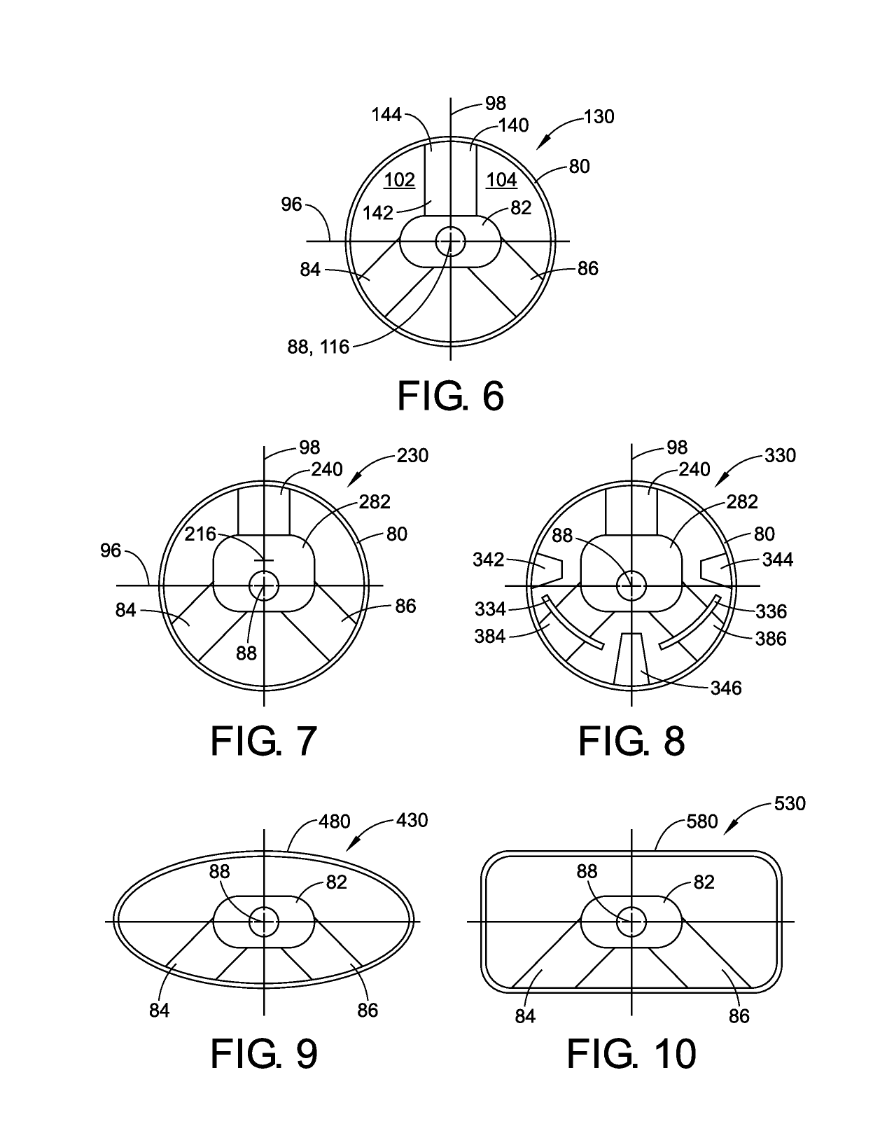

FIGS. 6-10 each depict alternative embodiments of a compliance bush. The compliance bushes described below can connect with the trailing arm 42 (FIG. 2) in a manner similar to the compliance bush 30 described above.

FIG. 6 depicts an alternative embodiment of a compliance bush 130. The compliance bush 130 is similar in many respects to the compliance bush 30 depicted in FIGS. 4 and 5. As such, common reference numbers will be used to describe common elements. The compliance bush 130 includes the outer bush 80, the inner shaft 82, the first elastic member 84, and the second elastic member 86. The outer bush 80, the inner shaft 82, the first elastic member 84, and the second elastic member 86 are the same as those described with reference to FIGS. 4 and 5; therefore, further description thereof will not be provided. The compliance bush 130 further includes a third elastic member 140 connecting the inner shaft 82 to the outer tube 80. The third elastic member 140 is disposed generally along the vertical axis 98 and above the horizontal axis 96. The third elastic member includes a first end 142 connected with and contacting the inner shaft 82 and a second end 144 connected with and contacting the outer tube 80.

As illustrated in FIG. 6, the third elastic member 140 is at least partially disposed in each of the two upper quadrants 102, 104. Even for the embodiment depicted in FIG. 6, the bush 130 is devoid of at least one elastic member contacting the inner shaft 82 and the outer tube 80 and located entirely within one of the upper quadrants 102, 104. Instead, the third elastic member 140 is at least partially disposed in each of the upper two quadrants 102, 104. The third elastic member 140 is made from a material similar to the first and second elastic members 84, 86. The compliance bush 130 operates in a manner similar to that shown in FIG. 5 in that the center axis 116 of the inner shaft 82 is capable of lateral displacement from the central axis 88 of the outer tube 80 during a braking event.

FIG. 7 depicts another embodiment of a compliance bush 230. The compliance bush 230 includes the outer tube 80, an inner shaft 282, the first elastic member 84 and the second elastic member 86. The outer tube 80, the first elastic member 84 and the second elastic member 86 are all similar to the embodiments described in FIGS. 4-6. The inner shaft 282 is different in configuration as compared with the inner shaft 82. The inner shaft 282 defines a center axis 216 about which the inner shaft 282 is centered. The center axis 216 is offset from the central axis 88 of the outer tube 80. In the embodiment depicted in FIG. 7, the center axis 216 is offset above the central axis 88. The compliance bush 230 further includes a third elastic member 240 connecting the inner shaft 282 to the outer tube 80. The third elastic member 240 is disposed generally along the vertical axis 98 and above the horizontal axis 96, which is similar to the embodiments described above with reference to FIGS. 4-6. The compliance bush 230 can operate in a manner similar to the compliance bush 30 depicted in FIGS. 4 and 5. As such, the rotational axis 66 of the trailing arm 42 can translate a distance D during a braking event.

An alternative embodiment of a compliance bush 330 is depicted in FIG. 8. The compliance bush 330 includes the outer tube 80, the inner shaft 282, which is similar to the inner shaft depicted in FIG. 7, a first elastic member 384, a second elastic member 386, and the third elastic member 240, which is similar to the third elastic member depicted in FIG. 7. The first elastic member 384 connects with a curved plate 334 that is fixed to and moves with the first elastic member 384 during a braking event. Similarly, the second elastic member 386 connects with a curved plate 336 such that the curved plate 336 moves with the second elastic member 386 during a braking event. Each of the curved plates 334 and 336 is disposed between the outer tube 80 and the inner shaft 282. The curvature of each of the plates generally follows a radius defined by the central axis 88 of the outer tube 80. The curved plates 334, 336 cooperate with stoppers 342, 344, and 346 to limit movement of the inner shaft 282 with respect to the outer tube 80 during a braking event. Each stopper 342, 344, 346 is connected with and extends inwardly from the outer tube 80. Each plate 334, 336 is configured to contact a respective stopper 342, 344, 346 when the inner shaft 282 rotates with respect to the outer tube 80 during the braking event.

Stoppers 342 and 344 are disposed on opposite sides of the vertical axis 98 and each is generally disposed above the horizontal axis 96. The stopper 346 can be referred to as a lower stopper and is disposed along the vertical axis 98. The lower stopper 346 is interposed between the first elastic member 384 and the second elastic member 386.

During a braking event, the first curved plate 334 connected with the first elastic member 384 contacts the lower stopper 346. Also during the braking event, the second curved plate 336 connected with the second elastic member 386 contacts the right-hand stopper 344. After the braking event, the inner shaft 282 can rotate with respect to the outer tube 80 in an opposite direction such that the first curved plate 334 connected with the first elastic member 384 contacts the left-hand stopper 342 and the second curved plate 336 connected with the second elastic member 386 contacts the lower stopper 346. The compliance bush 330 depicted in FIG. 8 can operate in a similar manner to the compliance bush 30 depicted in FIG. 5 in that the pivot axis 66 of the trailing arm 42, which connects with the compliance bush 330, can translate a distance D from the central axis 88 of the outer tube 80 during the braking event.

FIG. 9 depicts an alternative embodiment of a compliance bush 430. As depicted in FIG. 9, the compliance bush 430 includes an outer tube 480, the inner shaft 82, the first elastic member 84 and the second elastic member 86. The inner shaft 82, the first elastic member 84, and the second elastic member 86 are all similar in configuration as that shown in FIGS. 4 and 5. The compliance bush 430 differs from the compliance bush 30 shown in FIGS. 4 and 5 in that the outer tube 480 is elliptical in a cross-section taken normal to the central axis 88 of the outer tube. Nevertheless, the pivot axis 66 of the trailing arm 42 (FIG. 3) is still capable of horizontal displacement D with respect to the central axis 88 of the outer tube 480 during a braking event.

FIG. 10 depicts another alternative embodiment of a compliance bush 530. The compliance bush 530 includes an outer tube 580, the inner shaft 82, the first elastic member 84, and the second elastic member 86. The compliance bush 530 differs from the compliance bush 30 depicted in FIGS. 4 and 5 in that the outer tube 580 is substantially rectangular in a configuration taken normal to the central axis 88. Nevertheless, the compliance bush 530 can operate in a similar manner to the compliance bush 30 depicted in FIGS. 4 and 5 in that the pivot axis 66 of the trailing arm 42 (FIG. 3) can displace horizontally a distance D during a braking event. For the embodiments depicted in FIGS. 9 and 10, a third elastic member can also be provided similar to the elastic members 140 and 240 described above.

Examples of a compliance bush for a rear suspension of a vehicle has been described above with particularity. Modifications and alternations will occur to those upon reading and understanding the preceding detailed description. The invention, however, is not limited to only the embodiments described above. Instead, the invention is broadly defined by the appended claims and the equivalents thereof. Also, various presently unforeseen or unanticipated alternatives, modifications, variations or improvements therein may be subsequently made by those skilled in the art which are also intended to be encompassed by the following claims.

1. A compliance bush for a rear suspension of a vehicle, the bush comprising:
an outer tube defining a central axis, wherein a horizontal axis intersects the central axis and a vertical axis intersects the horizontal axis and the central axis to divide the bush into two upper quadrants and two lower quadrants;
an inner shaft received in the outer tube and configured to rotate in a first rotational direction with respect to the outer tube during a braking event, wherein in a cross section taken normal to the central axis the inner shaft is elongated in a horizontal direction;
a first elastic member connecting the inner shaft to the outer tube, the first elastic member being substantially disposed within a first lower quadrant of the two lower quadrants, wherein the first elastic member includes a first end connected with and contacting the inner shaft and a second end connected with and contacting the outer tube; and
a second elastic member connecting the inner shaft to the outer tube, the second elastic member being disposed on an opposite side of the vertical axis as the first elastic member and substantially disposed within a second lower quadrant of the two lower quadrants, wherein the second elastic member includes a first end connected with and contacting the inner shaft and a second end connected with and contacting the outer tube,
wherein the bush is devoid of at least one elastic member contacting the inner shaft and the outer tube and located entirely within one of the upper quadrants.

2. The bush of claim 1, further comprising a third elastic member connecting the inner shaft to the outer tube, the third elastic member being disposed generally along the vertical axis and above the horizontal axis, wherein the third elastic member includes a first end connected with and contacting the inner shaft and a second end connected with and contacting the outer tube and the third elastic member is at least partially disposed in each of the two upper quadrants.

3. The bush of claim 1, wherein the bush is substantially devoid of further elastic members contacting the inner shaft and the outer tube in each of the two upper quadrants.

4. The bush of claim 1, wherein the inner shaft defines a center axis, wherein the center axis is offset from the central axis.

5. The bush of claim 4, wherein the center axis is offset above the central axis.

6. The bush of claim 1, wherein the inner shaft includes a bore configured to receive a shaft, wherein the inner shaft defines a center axis, wherein the bore is coaxial with the central axis and offset from the center axis.

7. The bush of claim 1, wherein the second end of the first elastic member is circumferentially spaced along the outer tube from the second end of the second elastic member.

8. The bush of claim 1, wherein the inner shaft has a configuration in the cross section taken normal to the central axis that differs a configuration of the outer tube in the cross section taken normal to the central axis.

9. A compliance bush for a rear suspension of a vehicle, the bush comprising:
an outer tube defining a central axis;
an inner shaft received in the outer tube and configured to rotate in a first rotational direction with respect to the outer tube during a braking event, wherein the inner shaft defines a center axis parallel or coaxial with the central axis and in a cross section taken normal to the center axis the inner shaft is elongated in a horizontal direction;
a first elastic member connecting the inner shaft to the outer tube, wherein the first elastic member contacts the inner shaft at a first end and contacts the outer tube at a second end; and
a second elastic member connecting the inner shaft to the outer tube, the second elastic member being disposed on an opposite side of the vertical axis as the first elastic member, wherein the second elastic member contacts the inner shaft at a first end and contacts the outer tube at a second end,
wherein the outer tube, the inner shaft, the first elastic member and the second elastic member are each configured such that rotation of the inner shaft with respect to the outer tube in the first rotational direction results in lateral movement a distance D of a point on the inner shaft that was intersected by the horizontal axis and the vertical axis prior to rotation of the inner shaft.

10. The bush of claim 9, wherein the first elastic member is disposed downwardly at an angle A from the horizontal axis toward the vertical axis, wherein the second elastic member is disposed downwardly at an angle C from the horizontal axis toward the vertical axis.

11. The bush of claim 10, where angle A is substantially equal to angle C.

12. The bush of claim 9, further comprising a third elastic member connecting the inner shaft to the outer tube, the third elastic member intersecting the vertical axis and disposed above the horizontal axis, wherein the third elastic member contacts the inner shaft at a first end and contacts the outer tube at a second end.

13. The bush of claim 9, wherein the center axis is offset from the central axis.

14. The bush of claim 13, wherein the center axis is offset above the central axis.

15. The bush of claim 9, further comprising a stopper connected with and extending inwardly from the outer tube, and a plate connected with at least one of the elastic members and offset from the inner shaft and the outer tube, wherein the plate is configured to contact the stopper when the inner shaft rotates with respect to the outer tube during the braking event.

16. The bush of claim 9, further comprising a stopper connected with and extending inwardly from the outer tube, and a plate connected with at least one of the elastic members and offset from the inner shaft and the outer tube, wherein the stopper is disposed below the horizontal axis and between the first elastic member and the second elastic member.

17. A compliance bush for a rear suspension of a vehicle, the bush comprising:
an outer tube defining a central axis, wherein a horizontal axis intersects the central axis and a vertical axis intersects the horizontal axis and the central axis to divide the bush into two upper quadrants and two lower quadrants;
an inner shaft received in the outer tube and configured to rotate in a first rotational direction with respect to the outer tube during a braking event, wherein the inner shaft defines a center axis parallel or coaxial with the central axis and in a cross section taken normal to the center axis the inner shaft is elongated in a horizontal direction;
a first elastic member connecting the inner shaft to the outer tube, the first elastic member being substantially disposed within a first lower quadrant of the two lower quadrants, wherein the first elastic member includes a first end connected with and contacting the inner shaft and a second end connected with and contacting the outer tube; and
a second elastic member connecting the inner shaft to the outer tube, the second elastic member being disposed on an opposite side of the vertical axis as the first elastic member and substantially disposed within a second lower quadrant of the two lower quadrants, wherein the second elastic member includes a first end connected with and contacting the inner shaft and a second end connected with and contacting the outer tube,
wherein the bush is devoid of at least one elastic member contacting the inner shaft and the outer tube and located at least substantially within at least one of the upper quadrants and angularly offset from the vertical axis.

18. The bush of claim 17, further comprising a third elastic member connecting the inner shaft to the outer tube, the third elastic member being disposed generally along the vertical axis and above the horizontal axis, wherein the third elastic member contacts the inner shaft at a first end and contacts the outer tube at a second end.

19. The bush of claim 17, wherein the inner shaft includes a bore configured to receive a shaft, the bore being coaxial with the central axis and offset from the center axis.

20. The bush of claim 17, wherein the bush is substantially devoid of further elastic members contacting the inner shaft and the outer tube in each of the two upper quadrants.
